(19) United States
(12) Patent Application Publication
(10) Pub. No.: US 2018/0332815 A1
(43) Pub. Date: Nov. 22, 2018

(54) ARTIFICIAL MULCH CLEANING SYSTEM

(71) Applicant: Joseph Andrew Hajda, Broken Bow, NE (US)

(72) Inventor: Joseph Andrew Hajda, Broken Bow, NE (US)

(21) Appl. No.: 15/980,888

(22) Filed: May 16, 2018

Related U.S. Application Data
(60) Provisional application No. 62/508,011, filed on May 18, 2017.

(51) Int. Cl. A01K 1/01; B03B 5/22; B03B 5/24

(52) U.S. Cl. CPC A01K 1/0135; A01K 1/0128; A01K 1/0154; B03B 5/24; B03B 5/22

(57) ABSTRACT

An artificial mulch cleaning system includes a vehicle with a housing having a front end, a back end and a plurality of wheels. A collecting assembly is attached to and extends forward of the front end. The gathering assembly has a distal end with respect to the front end. The distal end engages and captures rubber mulch positioned on the ground surface. A cleansing assembly is mounted on the vehicle rearward of and in communication with the collecting assembly. The cleansing assembly cleans the rubber mulch brought into the vehicle by the collecting assembly. A spreading assembly is attached to vehicle and is in communication with the cleansing assembly such that the spreading assembly receives the rubber mulch from the cleansing assembly. The spreading assembly dispenses the rubber mulch from the back end of the vehicle.

### CROSS-REFERENCE TO RELATED APPLICATIONS

I hereby claim the benefit under 35 U.S.C. Section 119(e) of U.S. Provisional application 62/508,011 filed May 18, 2017.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to rubber mulch cleaning devices and more particularly pertains to a new rubber mulch cleaning device for cleaning rubber mulch that is being utilized as animal bedding.

### BRIEF SUMMARY OF THE INVENTION

An embodiment of the disclosure meets the needs presented above by generally comprising a vehicle configured for being driven over the ground surface. The vehicle includes a housing having a front end, a back end and a plurality of wheels that are attached to the housing and support the housing on the ground surface. A collecting assembly is attached to and extends forward of the front end. The gathering assembly has a distal end with respect to the front end. The distal end is configured to engage and capture rubber mulch positioned on the ground surface. A cleansing assembly is mounted on the vehicle rearward of and in communication with the collecting assembly. The cleansing assembly cleans the rubber mulch brought into the vehicle by the collecting assembly. A spreading assembly is attached to vehicle and is in communication with the cleansing assembly such that the spreading assembly receives the rubber mulch from the cleansing assembly. The spreading assembly is configured to dispense the rubber mulch from the back end of the vehicle.

The embodiment described above solves many problems associated with caring for livestock. In particular, the embodiment improves the handling and removal of manure as a single device may be utilized for performing this task to reduce the costs of equipment and operations related to this task. The system, including its usage of rubber mulch, will facilitate livestock wellbeing as their bedding will be more sanitary, dryer, provide shielding from frozen ground surfaces (this keeping the animals warmer and reduce need of feed used for body temperature maintenance), and reduce livestock exposure to parasites. Furthermore, the cleaning of the rubber mulch will reduce dust and other allergens which can be the cause of respiratory illness in livestock herds. The above will lead to cleaner hides and healthier animals which in turn will increase their value to the owners of the livestock. These benefits will also extend to the workers caring for the livestock as the workers are also exposed to any pathogens and diseases which are magnified by unsanitary conditions. Moreover, by controlling the excrement of the livestock in the manner described herein, waste water runoff can be moderated with far greater efficiency than previous methods. The results of above will lead to odor control, less air and water pollution, and improved health conditions for the livestock and those who work with and live near them.

While the above system includes teachings related, with particularity, toward livestock maintenance, it should be understood that devices herein described for cleaning rubber mulch may be used to clean rubber mulch found in playgrounds, kennels, sports field, walkways, and like. Essentially, the rubber mulch may be cleaned from all contaminants associated with contact by animals, people, or the environment in general.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of an artificial mulch cleaning system according to an embodiment of the disclosure.

FIG. 2 is a left side view of an embodiment of the disclosure.

FIG. 3 is an exploded side view of an embodiment of the disclosure.

FIG. 4 is a bottom view of nozzles of an embodiment of the disclosure.

FIG. 5 is a front view of an embodiment of the disclosure.

FIG. 6 is a rear view of an embodiment of the disclosure.

FIG. 7 is a top broken view of an embodiment of the disclosure.

FIG. 8 is a schematic view of an embodiment of the disclosure.

### DETAILED DESCRIPTION OF THE INVENTION

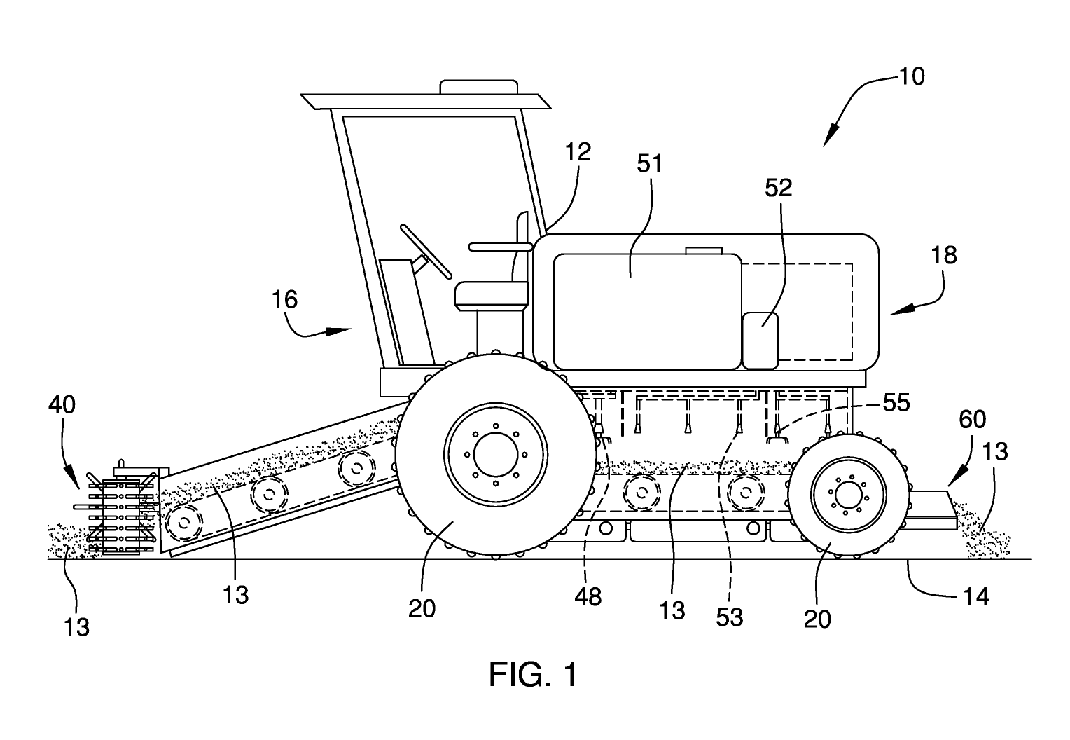

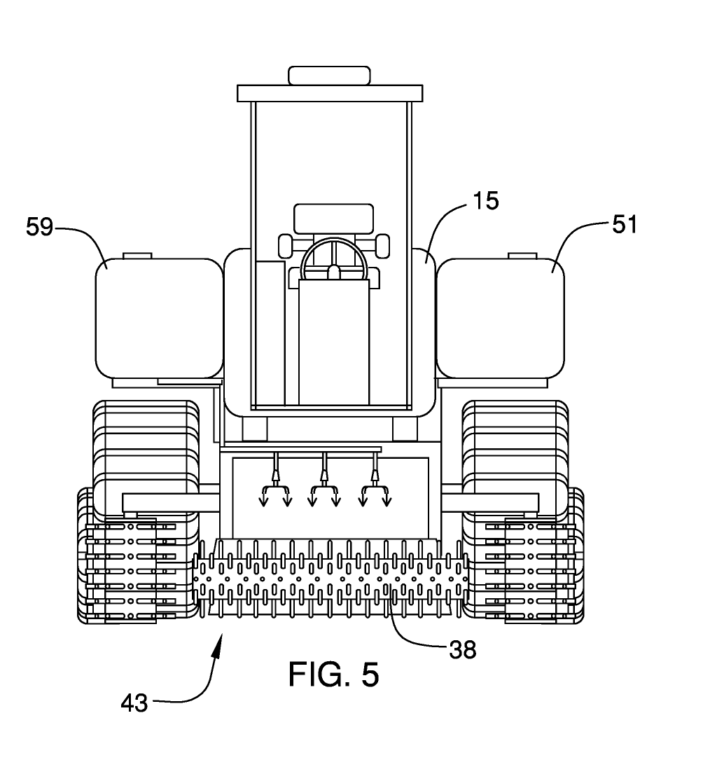

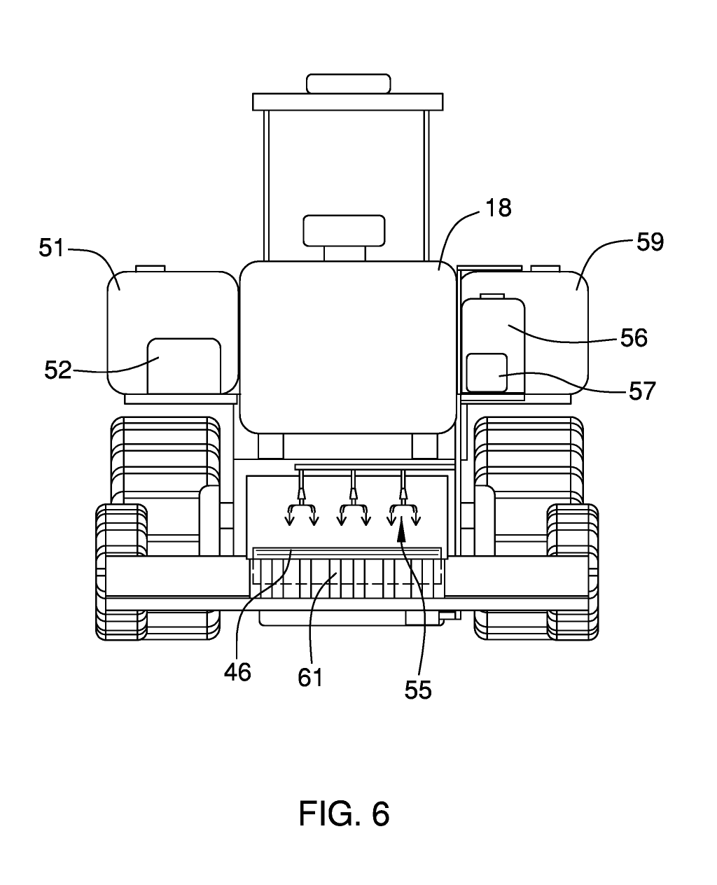

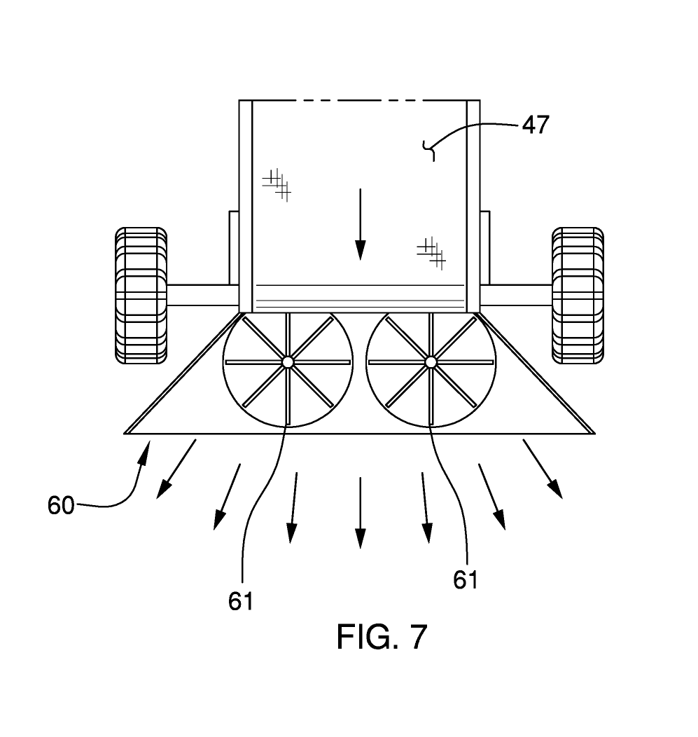

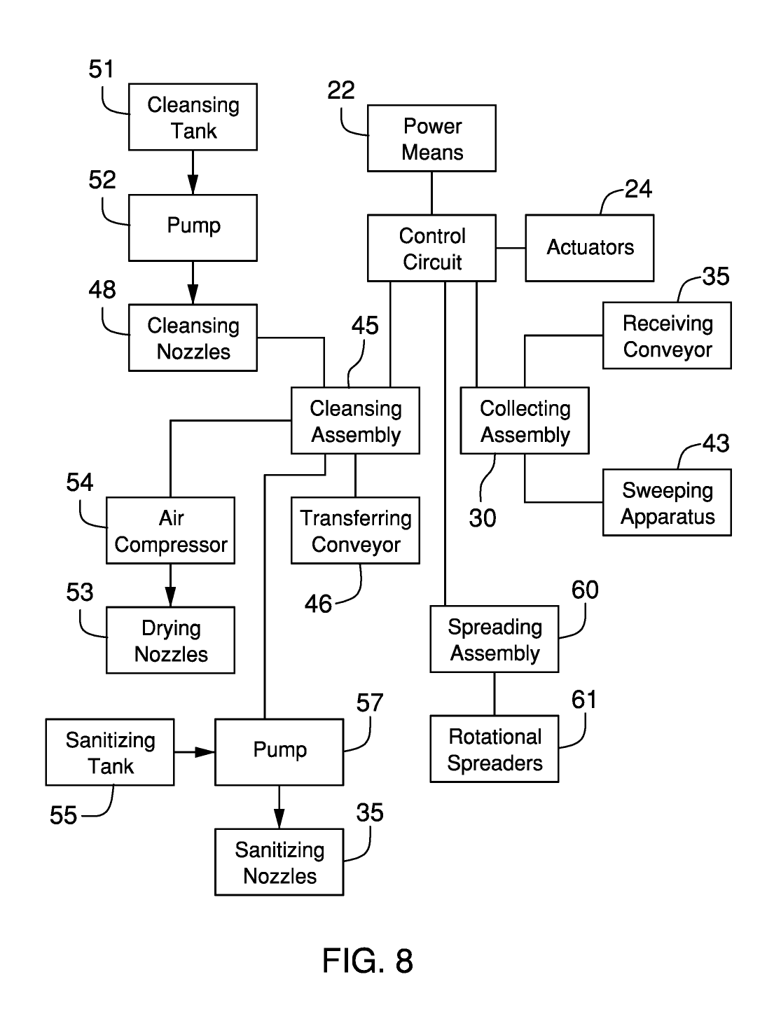

With reference now to the drawings, and in particular to FIGS. 1 through 8 thereof, a new rubber mulch cleaning device embodying the principles and concepts of an embodiment of the disclosure and generally designated by the reference numeral 10 will be described.

As best illustrated in FIGS. 1 through 8, the artificial mulch cleaning system 10 generally comprises any conventional powered vehicle 12 configured for being driven over a ground surface 14. The vehicle 12 includes a housing 15 having a front end 16, a back end 18 and a plurality of wheels 20 that are attached to the housing 15 and support the housing 15 on the ground surface 14. The vehicle 12 may comprise any conventional vehicle having a chassis which incorporates a frame, wheels, and power means 22 such as an electric motor and accompanying batteries or a motor powered by propane, diesel fuel, gasoline and any other comparable fuel. The vehicle 12 would include conventional steering and driving capabilities and therefore may include trucks, tractors and other similar vehicles. Typically, the vehicle 12 will be selected from those vehicles that are most often used with farming, livestock caretaking and the like, though a unique vehicle may be utilized and, in particular, may incorporate a steering mechanism wherein the rear wheels are used for steering the vehicle 12.

A collecting assembly 30 is attached to and extends forward of the front end 16 of the vehicle 12. The gathering assembly 30 has a distal end 31 with respect to the front end 16 wherein the distal end 31 is configured to engage and capture rubber mulch 13 positioned on the ground surface 14. Rubber mulch 13 is a ubiquitous material used in ways similar to conventional mulch and is being used more frequently due to its ability to last longer than wood mulch and because it is comprised of recycled materials such as recycled tires. The rubber mulch 13 may be used to replace other materials used for animal bedding and the rubber mulch 13 would typically be placed on a hardened ground surface 14, such as a concrete ground surface. The concrete ground surface prevents the rubber mulch 13 from sinking into to the ground surface 14 as well as acts as a fluid and microbe barrier.

The collecting assembly 30 includes a ramp 32 that has an attached end 33 coupled to the vehicle 12 and a free end 34 positioned opposite of the attached end 33. The ramp 32 may be fixed or may be pivotally coupled to the vehicle 12 to allow lowering or raising of the free end 34. Alternatively, the ramp 32 may telescopic to allow its extension or retraction. A receiving conveyor 35 is positioned on the ramp 32 and has an upper surface 36 moving rearwardly from the free end 34 to the attached end 33 when the receiving conveyor 35 is turned on. The receiving conveyor 35 may comprise an endless belt loop and the ramp 32 may be positioned beneath the endless loop or may comprise a framework upon which the endless belt loop is mounted.

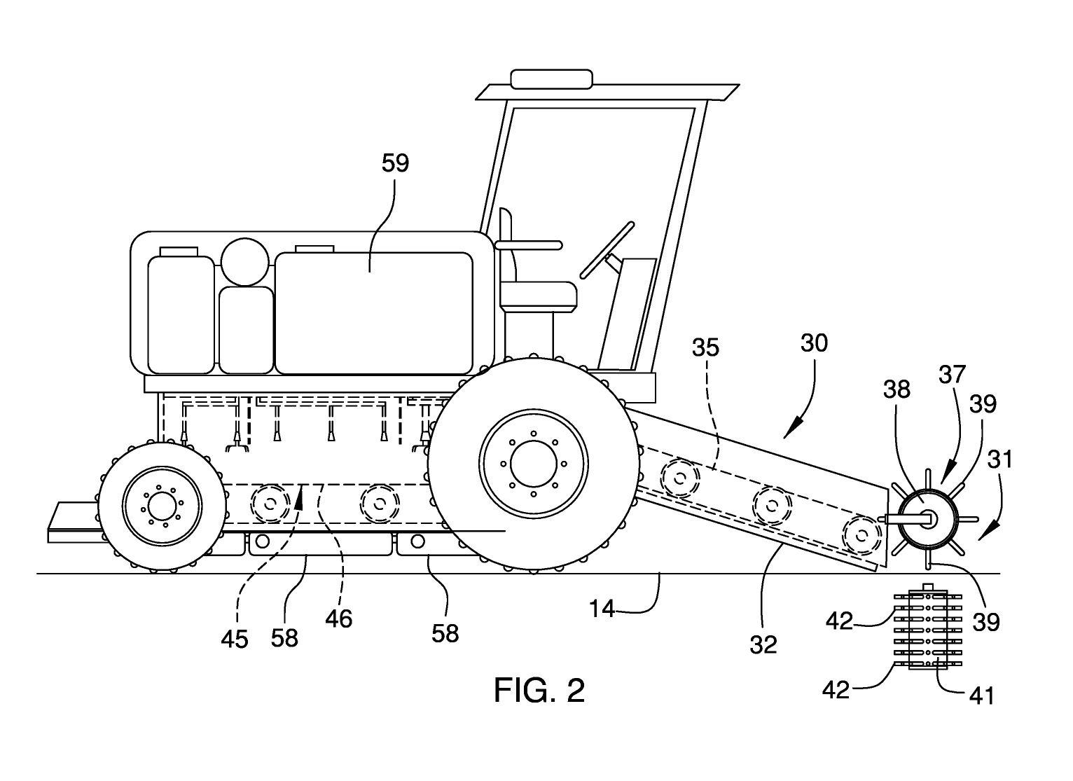

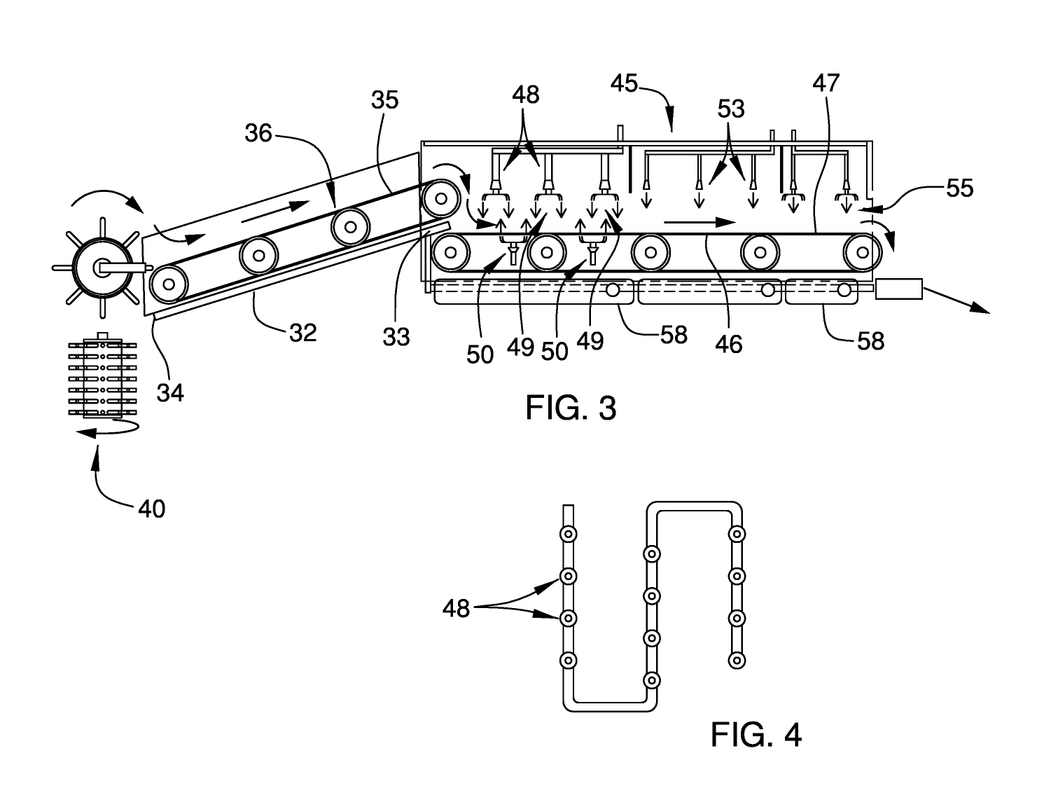

The collecting assembly 30 further includes a sweeping apparatus 43 that is attached to the ramp 34 adjacent to the distal end 34 and is configured to urge the rubber mulch 13 onto the receiving conveyor 35. The sweeping apparatus 43 includes a horizontal sweep 37 having a horizontal axle 38 with a plurality of vertical bristles 39 mounted thereto. The horizontal axle 38 rotates the vertical bristles 39 from an area forward of the ramp 34 toward the ramp 34 when the horizontal sweep 37 is actuated to an engaged condition. Thus, material below the horizontal axle 38 is moved toward the ramp 34 by the horizontal sweep 37. A pair of vertical sweeps 40 is provided and each includes a vertical axle 41. Each vertical axle 41 has a plurality of horizontal bristles 42 mounted thereto. The horizontal axle 38 is positioned between the vertical axles 41. The vertical axles 41 rotate the horizontal bristles 42 from an area lateral of the horizontal sweep 37 and toward an area forward of the horizontal sweep 37. FIGS. 2 and 3 have separated the vertical axles 41 for clarity purposes.

A cleansing assembly 45 is mounted on the vehicle 12 rearward of and in communication with the collecting assembly 30. The cleansing assembly 45 cleans the rubber mulch 13 brought into the vehicle 12 by the collecting assembly 30. The purpose of cleaning the rubber mulch 13 is to remove urine, fecal matter and other particulates from the rubber mulch 13 to reduce odor and the spread of insects and bacteria. The cleansing assembly 45 includes a transferring conveyor 46 extending from the collecting assembly 30 to an area adjacent to a back end 18 of the vehicle 12. The transferring conveyor 46 may comprise an endless loop belt and may, alternatively, be a continuation of the receiving conveyor 35. The transferring conveyor 46 has a top side 47 for receiving the rubber mulch 13 from the collecting assembly 30. The transferring conveyor 46 moves the rubber mulch 13 from the collecting assembly 30 to the back end 18 of the vehicle 12 when the transferring conveyor 46 is engaged. The transferring conveyor 46 is perforated to allow fluids and small particles to pass through the transferring conveyor 46 while retaining the rubber mulch 13 on the transferring conveyor 46. The rubber mulch 13 typically has a smallest diameter equal to at least ⅜ inch and therefore it may be beneficial to have apertures in the transferring conveyor 46 with diameters being equal to or less than ¼ inch.

The cleansing assembly 45 further includes a plurality of cleansing nozzles 48 directed at the transferring conveyor 46. The cleansing nozzles 48 are positioned in a forward area of the vehicle 12 adjacent to the collecting assembly 30. The plurality of cleansing nozzles 48 may include a plurality of upper nozzles 49 directed downwardly at the top side 47 of the transferring conveyor 46 and a plurality of lower nozzles 50 positioned below and directed upwardly toward and below the top side 47 such that fluid ejected therefrom flows through the top side 47. As can be seen in the Figures, the lower nozzles 50 may be positioned within the closed loop belt of the transferring conveyor 46. A cleansing tank 51 configured for holding a cleansing fluid is mounted on the vehicle 12 and is fluidly coupled to the cleansing nozzles 48. The cleansing nozzles 48 spray the cleansing fluid on the transferring conveyor 46. The cleansing fluid may comprise water alone or may include a detergent or other additive, though water is preferred for a first cleaning stage to remove large particulate from the rubber mulch 13. A pump 52 may be in fluid communication with the cleansing nozzles 48 to pressurize the cleansing fluid as it is ejected from the cleansing nozzles 48. As can be seen in FIG. 4, the cleansing nozzles 48 may be arranged in a serpentine pattern to ensure the rubber mulch particles 13 are each subjected to multiple cleansing fluid discharges.

A plurality of drying nozzles 53 may be positioned above and directed at the top side 47 of the transferring conveyor 46. The drying nozzles 53 are positioned between the cleansing nozzles 48 and the back end 18. A compressed air source, such as an air compressor 54, is fluidly coupled to the drying nozzles 53 such that the drying nozzles 53 force air downwardly onto the top side 47. The drying nozzles 53 remove excess fluid from the rubber mulch 13 and may be utilized, particularly, when ambient temperatures are below 0° C. to prevent the freezing together of the rubber mulch 13 particles.

A plurality of sanitizing nozzles 55 is positioned above and directed at the top side 47 of the transferring conveyor 46. The sanitizing nozzles 55 are positioned between the cleansing nozzles 48 and the back end 18 of the vehicle 12. A sanitizing tank 56 configured for holding a sanitizing fluid is mounted on the vehicle 12 and is fluidly coupled to the sanitizing nozzles 55 to spray the sanitizing fluid on the transferring conveyor 46. The sanitizing fluid may comprise any conventional fluid used for disinfecting and which is safe for usage with animals. One acceptable sanitizing fluid is sodium hypochlorite, commonly known as bleach, which may be combined with water at an effective concentration. The sanitizing fluid may be pressurized with a pump 57 to atomize the sanitizing fluid as it is dispersed onto the rubber mulch 13.

At least one catch bin 58 is positioned below the transferring conveyor 46 and is configured to capture fluids and particulate moving downwardly through the transferring conveyor 46. The catch bin 58 may be hingedly coupled to the vehicle 12 such that it can swing downwardly and possibly detach from the vehicle 12 to facilitate emptying thereof. The catch bin 58 may be fluidly coupled to a waste storage tank 59. As can be seen in the Figures, multiple catch bins 58 may be provided such that one is aligned with the cleansing nozzles 48, one catch bin 58 is aligned with the drying nozzles 53 and one catch bin 58 is aligned with the sanitizing nozzles 55. The water captured from the cleansing nozzles 48, in particular, may be retained and held in a retention pond for later re-use. Pumps may be provided to draw fluid from the catch bin(s) 58 and into the waste storage tank(s) 59.

A spreading assembly 60 is attached to vehicle 12 and in communication with the cleansing assembly 45 such that the spreading assembly 60 receives the rubber mulch 13 from the cleansing assembly 45. The spreading assembly 60 is configured dispense the rubber mulch 13 from the back end 18 of the vehicle 12. The spreading assembly 60 may include one or more rotational spreaders 61 having fins thereon, such that impellers are formed, which are configured to widely disperse the rubber mulch as the impellers are mechanically rotated.

Each of the receiving conveyor 35, sweeping apparatus 43, transferring conveyor 46 and rotational spreaders 61 may be driven by any conventional drive means or power assemblies as a particular selection of power sources will not affect the operation of the system 10 and drive systems for conveyors, sweepers and spreaders are well known in the art. For example, each may be engageable with the power means 22 of the vehicle 12 by actuating drive gears releasably engaging these structures with the power means 22. However, it may be beneficial to have certain ones of these elements powered by one type of drive means and others by different drive means. Thus, electric motors or hydraulic motors may be utilized where convenient and where required. For instance, it may be beneficial to mechanically couple the receiving conveyor, horizontal axle and vertical axles together by way of gears such that rotation of one will cause rotational engagement of all components of the collection assembly. The transferring conveyor may include a dedicated motor for rotation of the transferring conveyor or may utilize the drive means utilized by the collection assembly. Likewise, the rotational spreaders may include an electric, pneumatic or hydraulic drive means or may be in communication with the power means of the vehicle or the drive means of the transferring conveyor. Each of the power means 22, collecting 30, cleansing 45, and spreading 60 assemblies may be turned on or off with conventional actuators 24.

In use, the rubber mulch 13 is positioned on a hardened ground surface 14, such as concrete, to act as animal bedding for livestock, in particular. After a period of use, the rubble mulch 13 will become soiled from the livestock as well as retain dirt from the livestock and airborne particulate and will require cleaning as the livestock urine and manure cannot move beyond the concrete. The vehicle 12 is then used to gather, clean and re-distribute the rubber mulch 13 to increase its useful life, reduce odor and promote sanitary conditions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rubber mulch cleaning and redistributing assembly configured to gather, clean and dispense rubber mulch from a ground surface, the assembly comprising:
a vehicle configured for being driven over the ground surface, the vehicle including a housing having a front end, a back end and a plurality of wheels being attached to the housing and supporting the housing on the ground surface;
a collecting assembly being attached to and extending forward of the front end, the gathering assembly having a distal end with respect to the front end, the distal end being configured to engage and capture rubber mulch positioned on the ground surface;
a cleansing assembly being mounted on the vehicle rearward of and in communication with the collecting assembly, the cleansing assembly cleaning the rubber mulch brought into the vehicle by the collecting assembly; and
a spreading assembly being attached to vehicle and in communication with the cleansing assembly such that the spreading assembly receives the rubber mulch from the cleansing assembly, the spreading assembly being configured to dispense the rubber mulch from the back end of the vehicle.

2. The rubber mulch cleaning and redistributing assembly according to claim 1, wherein the collecting assembly includes:
a ramp having an attached end coupled to the vehicle and a free end positioned opposite of the attached end;
a receiving conveyor being positioned on the ramp, the receiving conveyor having an upper surface moving rearwardly from the free end to the attached end when the receiving conveyor belt is turned on; and
a sweeping apparatus being attached to the ramp adjacent to the distal end and being configured to urge the rubber mulch onto the receiving conveyor.

3. The rubber mulch cleaning and redistributing assembly according to claim 2, wherein the sweeping apparatus includes:
a horizontal sweep including a horizontal axle having a plurality of vertical bristles mounted thereto, the horizontal axle rotating the vertical bristles from an area forward of the ramp toward the ramp when the horizontal sweep is actuated to an engaged condition; and
a pair of vertical sweeps each including a vertical axle, each of the vertical axles having a plurality of horizontal bristles mounted thereto, the horizontal axle being positioned between the vertical axles, the vertical axles rotating the horizontal bristles from an area lateral of the horizontal sweep toward an area forward of the horizontal sweep.

4. The rubber mulch cleaning and redistributing assembly according to claim 1, wherein the collecting assembly includes:
a transferring conveyor extending from the collecting assembly to an area adjacent to a back end of the vehicle, the transferring conveyor having a top side for receiving the rubber mulch from the collecting assembly, the transferring conveyor moving the rubber mulch from the collecting assembly to the back end of the vehicle when the transferring conveyor is engaged; and
a plurality of cleansing nozzles being directed at the transferring conveyor;
a cleansing tank configured for holding a cleansing fluid being mounted on the vehicle and being fluidly coupled to the cleansing nozzles, the cleansing nozzles spraying the cleansing fluid on the transferring conveyor.

5. The rubber mulch cleaning and redistributing assembly according to claim 4, wherein the transferring conveyor is perforated to allow fluids and small particles to pass through the transferring conveyor while retaining the rubber mulch on the transferring conveyor.

6. The rubber mulch cleaning and redistributing assembly according to claim 5, wherein the plurality of cleansing nozzles includes a plurality of upper nozzles being directed downwardly at the top side of the transferring conveyor and a plurality of lower nozzles positioned below and directed upwardly at the top side.

7. The rubber mulch cleaning and redistributing assembly according to claim 4, wherein the plurality of cleansing nozzles includes a plurality of upper nozzles being directed downwardly at the top side of the transferring conveyor and a plurality of lower nozzles positioned below and directed upwardly at the top side.

8. The rubber mulch cleaning and redistributing assembly according to claim 4, further including:
a plurality of drying nozzles being positioned above and directed at the top side of the transferring conveyor, the drying nozzles being positioned between the cleansing nozzles and the back end; and
a compressed air source being fluidly coupled to the drying nozzles such that the drying nozzles force air downwardly onto the top side.

9. The rubber mulch cleaning and redistributing assembly according to claim 8, further including:
a plurality of sanitizing nozzles being positioned above and directed at the top side of the transferring conveyor, the sanitizing nozzles being positioned between the cleansing nozzles and the back end of the vehicle; and
a sanitizing tank configured for holding a sanitizing fluid being mounted on the vehicle and being fluidly coupled to the sanitizing nozzles to spray the sanitizing fluid on the transferring conveyor.

10. The rubber mulch cleaning and redistributing assembly according to claim 4, further including:
a plurality of sanitizing nozzles being positioned above and directed at the top side of the transferring conveyor, the sanitizing nozzles being positioned between the cleansing nozzles and the back end of the vehicle; and
a sanitizing tank configured for holding a sanitizing fluid being mounted on the vehicle and being fluidly coupled to the sanitizing nozzles to spray the sanitizing fluid on the transferring conveyor.

11. The rubber mulch cleaning and redistributing assembly according to claim 4, further including at least one catch bin being positioned below the transferring conveyor and being configured to capture fluids and particulate moving downwardly through the transferring conveyor.

12. The rubber mulch cleaning and redistributing assembly according to claim 8, further including at least one catch bin being positioned below the transferring conveyor and being configured to capture fluids and particulate moving downwardly through the transferring conveyor.

13. The rubber mulch cleaning and redistributing assembly according to claim 9, further including at least one catch bin being positioned below the transferring conveyor and being configured to capture fluids and particulate moving downwardly through the transferring conveyor.

14. The rubber mulch cleaning and redistributing assembly according to claim 10, further including at least one catch bin being positioned below the transferring conveyor and being configured to capture fluids and particulate moving downwardly through the transferring conveyor.

15. A rubber mulch cleaning and redistributing assembly configured to gather, clean and dispense rubber mulch from a ground surface, the assembly comprising:
a vehicle configured for being driven over the ground surface, the vehicle including a housing having a front end, a back end and a plurality of wheels being attached to the housing and supporting the housing on the ground surface;
a collecting assembly being attached to and extending forward of the front end, the gathering assembly having a distal end with respect to the front end, the distal end being configured to engage and capture rubber mulch positioned on the ground surface, the collecting assembly including:
a ramp having an attached end coupled to the vehicle and a free end positioned opposite of the attached end;
a receiving conveyor being positioned on the ramp, the receiving conveyor having an upper surface moving rearwardly from the free end to the attached end when the receiving conveyor belt is turned on;
a sweeping apparatus being attached to the ramp adjacent to the distal end and being configured to urge the rubber mulch onto the receiving conveyor, the sweeping apparatus including:
a horizontal sweep including a horizontal axle having a plurality of vertical bristles mounted thereto, the horizontal axle rotating the vertical bristles from an area forward of the ramp toward the ramp when the horizontal sweep is actuated to an engaged condition;
a pair of vertical sweeps each including a vertical axle, each of the vertical axles having a plurality of horizontal bristles mounted thereto, the horizontal axle being positioned between the vertical axles, the vertical axles rotating the horizontal bristles from an area lateral of the horizontal sweep toward an area forward of the horizontal sweep;
a cleansing assembly being mounted on the vehicle rearward of and in communication with the collecting assembly, the cleansing assembly cleaning the rubber mulch brought into the vehicle by the collecting assembly, the cleansing assembly including:
a transferring conveyor extending from the collecting assembly to an area adjacent to a back end of the vehicle, the transferring conveyor having a top side for receiving the rubber mulch from the collecting assembly, the transferring conveyor moving the rubber mulch from the collecting assembly to the back end of the vehicle when the transferring conveyor is engaged, the transferring conveyor being perforated to allow fluids and small particles to pass through the transferring conveyor while retaining the rubber mulch on the transferring conveyor;
a plurality of cleansing nozzles being directed at the transferring conveyor, the cleansing nozzles being positioned in a forward area of the vehicle, the plurality of cleansing nozzles including a plurality of upper nozzles being directed downwardly at the top side of the transferring conveyor and a plurality of lower nozzles positioned below and directed upwardly at the top side;
a cleansing tank configured for holding a cleansing fluid being mounted on the vehicle and being fluidly coupled to the cleansing nozzles, the cleansing nozzles spraying the cleansing fluid on the transferring conveyor;
a plurality of drying nozzles being positioned above and directed at the top side of the transferring conveyor, the drying nozzles being positioned between the cleansing nozzles and the back end;
a compressed air source being fluidly coupled to the drying nozzles such that the drying nozzles force air downwardly onto the top side;
a plurality of sanitizing nozzles being positioned above and directed at the top side of the transferring conveyor, the sanitizing nozzles being positioned between the cleansing nozzles and the back end of the vehicle;
a sanitizing tank configured for holding a sanitizing fluid being mounted on the vehicle and being fluidly coupled to the sanitizing nozzles to spray the sanitizing fluid on the transferring conveyor;
at least one catch bin being positioned below the transferring conveyor and being configured to capture fluids and particulate moving downwardly through the transferring conveyor;
a spreading assembly being attached to vehicle and in communication with the cleansing assembly such that the spreading assembly receives the rubber mulch from the cleansing assembly, the spreading assembly being configured dispense the rubber mulch from the back end of the vehicle.
